(19) United States
(12) Patent Application Publication
(10) Pub. No.: US 2024/0338180 A1
(43) Pub. Date: Oct. 10, 2024

(54) SYSTEMS AND METHODS FOR DEVELOPING BUILDING COMPONENTS FOR A DEVICE APPLICATION

(71) Applicant: Engineer.ai Corp., Salt Lake City, UT (US)

(72) Inventors: Sachin Dev Duggal, Salt Lake City, UT (US); Utsav Preet, London (GB); Sithara Priyadarshini, London (GB); Rohan Patel, London (GB)

(73) Assignee: Engineer.ai Corp., Salt Lake City, UT (US)

(21) Appl. No.: 18/295,840

(22) Filed: Apr. 4, 2023

(51) Int. Cl. G06F 8/20

(52) U.S. Cl. CPC G06F 8/20

(57) ABSTRACT

Systems, methods, and computer readable storage mediums for developing a building component for a device application are disclosed. A method includes testing a first developer on a proficiency to develop building components, each of the building components comprising one or more functions that operate independently of other building components and determining a classification of the developer based on the testing. The method further includes assigning a first job, based on the classification, to the first developer to develop a first building component and evaluating a first completed building component to update the classification, the first completed building component based on the job to develop the first building component.

### FIELD OF THE INVENTION

This disclosure relates to software automation, machine learning AI, and project management.

### BACKGROUND

It is expected that a hired individual, be they an employee or an independent contractor, is qualified for the job to which they are hired. However, verifying a hiree's qualifications may be challenging. For instance, employees may have embellished or exaggerated on their resumes. And employees who have accurate resumes may still have skills they have atrophied to the point that they are no longer competent to do the same work. Further, employee skills may change over time. For instance, employees gain experience and knowhow as they work. On the other hand, some employees work product may decline for various reasons such as burnout or life changes. There is a need in the art for a better way of ascertaining a level of skill for employee when they are hired and during employment.

### SUMMARY

Systems, methods, and computer readable storage mediums for developing a device application are disclosed. A method for developing a device application includes determining a score for a developer and assigning, to the developer, a job based on a machine readable specification, the machine readable specification comprising one or more jobs that are completable by the developer. The method further includes receiving a completed job based on one of the one or more jobs and updating the score based on an assessment of the completed job. The score may be a classification that corresponds to a classification of the job. The method may further include determining the classification of the job based on the machine readable specification. The method may further include allocating one or more resources to the developer based on the classification. The assessment may be automatically performed by a computer system upon reception of the completed job. The assessment may be based on a comparison of the completed job with the job in the machine readable specification. The assessment may include a performance score on two or more portions of the completed job.

Another general aspect is a computer system configured to develop a device application. The computer system includes a processor coupled to a memory. The processor is configured to determine a score for a developer and assign, to the developer, a job based on a machine readable specification, the machine readable specification comprising one or more jobs that are completable by the developer. The processor is further configured to receive a completed job based on one of the one or more jobs and update the score based on an assessment of the completed job. The score may be a classification that corresponds to a classification of the job. The processor may be further configured to determine the classification of the job based on the machine readable specification. The processor may be further configured to allocate one or more resources to the developer based on the classification. The assessment may be automatically performed by a computer system upon reception of the completed job. The assessment may be based on a comparison of the completed job with the job in the machine readable specification. The assessment may include a performance score on two or more portions of the completed job.

An exemplary embodiment is a computer readable storage medium having data stored therein representing software executable by a computer. The software includes instructions that, when executed, cause the computer readable storage medium to determine a score for a developer and assign, to the developer, a job based on a machine readable specification. The machine readable specification includes one or more jobs that are completable by the developer. The instructions further cause the computer readable storage medium to receive a completed job based on one of the one or more jobs and update the score based on an assessment of the completed job. The score may be a classification that corresponds to a classification of the job. The instructions may further cause the computer readable storage medium to determine the classification of the job based on the machine readable specification. The instructions may further cause the computer readable storage medium to allocate one or more resources to the developer based on the classification. The assessment may be automatically performed by the computer readable storage medium upon reception of the completed job. The assessment may be based on a comparison of the completed job with the job in the machine readable specification.

Another general aspect is a method for evaluating a developer of a device application. The method includes receiving a classification for an application developer and determining, based on the classification, one or more tests to verify the classification. The method further includes assigning a job, based on the classification, to the developer where the job is determined by a machine readable specification. The method further includes determining a quality of a completed job and updating the classification of the application developer based on the quality of the completed job. The updating may include comparing the completed job to the machine readable specification. Evaluating the developer may include generating a test based on an experience of the developer. The test may be further based on one or more pending machine readable specifications. The evaluating may further include automatically determining a result of the test and comparing the result to the classification. The method may further include determining a difficulty of the job based on the machine readable specification where assigning includes matching the job to the experience and matching the classification to the difficulty of the job. The comparing may be performed automatically by a computing system.

An exemplary embodiment is a computer system configured to evaluate a developer for a device application. The computer system includes a processor coupled to a memory where the processor is configured to receive a classification for an application developer and determine, based on the classification, one or more tests to verify the classification. The processor is further configured to assign a job, based on the classification, to the developer, where the job is determined by a machine readable specification, and determine a quality of a completed job. The processor is further configured to update the classification of the application developer based on the quality of the completed job. The update may include comparing the completed job to the machine readable specification. The evaluation of the developer may include generating a test based on an experience of the developer. The test may be further based on one or more pending machine readable specifications. The evaluation of the developer may further include automatically determining a result of the test and comparing the result to the classification. The processor may be further configured to determine a difficulty of the job based on the machine readable specification where assigning includes the processor by further configured to match both the job to the experience and the classification to the difficulty of the job. The comparison may be performed automatically by the processor.

Another general aspect is a computer readable storage medium having data stored therein representing software executable by a computer. The software includes instructions that, when executed, cause the computer readable storage medium to perform receiving a classification for an application developer and determining, based on the classification, one or more tests to verify the classification. The instructions further cause the processor to perform assigning a job, based on the classification, to the developer, where the job is determined by a machine readable specification, and determining a quality of a completed job. The instructions further cause the processor to perform updating the classification of the application developer based on the quality of the completed job. The updating may include comparing the completed job to the machine readable specification. Evaluating the developer may include generating a test based on an experience of the developer. The test may be further based on one or more pending machine readable specifications. The evaluating may further include automatically determining a result of the test and comparing the result to the classification. The instructions may further cause the computer readable storage medium to perform determining a difficulty of the job based on the machine readable specification where assigning comprises matching the job to the experience and the classification to the difficulty of the job.

An exemplary embodiment is a method for developing a building component for a device application. The method includes testing a first developer on a proficiency to develop building components, each of the building components comprising one or more functions that operate independently of other building components and determining a classification of the developer based on the testing. The method further includes assigning a first job, based on the classification, to the first developer to develop a first building component and evaluating a first completed building component to update the classification. The first completed building component is based on the job to develop the first building component. The evaluating may include verifying that the first completed building component includes functions that operate independently of other building components. The method may further include assigning a second job to a second developer to develop a second building component and evaluating a second completed building component that is based on the second building component. The method may further include building a device application with the completed first building component and the completed second building component. Assigning the first job may include determining a difficulty of the first job where the method further includes matching the difficulty of the first job to the classification. Assigning the second job may include determining a difficulty of the second job where the method further includes matching the difficulty of the second job to a classification of the second developer. The method further includes updating the classification of the second developer based on an evaluation of the completed second building component.

Another general aspect is a computer system configured to develop a building component for a device application. The computer system includes a processor coupled to a memory. The processor is configured to test a first developer on a proficiency to develop building components where each of the building components include one or more functions that operate independently of other building components. The processor is further configured to determine a classification of the developer based on the testing. The processor is further configured to assign a first job, based on the classification, to the first developer to develop a first building component and evaluate a first completed building component to update the classification. The first completed building component is based on the job to develop the first building component. Evaluating the first completed building component may comprise the processor configured to verify that the first completed building component comprises functions that operate independently of other building components. The processor may be further configured to assign a second job to a second developer to develop a second building component and evaluate a second completed building component that is based on the second building component. The processor may be further configured to build a device application with the completed first building component and the completed second building component. Assigning the first job may include the processor further configured to determine a difficulty of the first job and match the difficulty of the first job to the classification. Assigning the second job may include the processor further configured to determine a difficulty of the second job and match the difficulty of the second job to a classification of the second developer. The processor may be further configured to update the classification of the second developer based on an evaluation of the completed second building component.

An exemplary embodiment is a computer readable storage medium having data stored therein representing software executable by a computer. The software includes instructions that, when executed, cause the computer readable storage medium to perform testing a first developer on a proficiency to develop building components where each of the building components include one or more functions that operate independently of other building components. The instructions further cause the computer readable storage medium to perform determining a classification of the developer based on the testing and assigning a first job, based on the classification, to the first developer to develop a first building component. The instructions further cause the computer readable storage medium to perform evaluating a first completed building component to update the classification where the first completed building component is based on the job to develop the first building component. The evaluating may include verifying that the first completed building component includes functions that operate independently of other building components. The instructions further cause the computer readable storage medium to perform assigning a second job to a second developer to develop a second building component and evaluating a second completed building component that is based on the second building component. The instructions may further cause the computer readable storage medium to perform building a device application with the completed first building component and the completed second building component. Assigning the first job may include determining a difficulty of the first job where the instructions further cause the computer readable storage medium to perform matching the difficulty of the first job to the classification. Assigning the second job may include determining a difficulty of the second job where the instructions further cause the computer readable storage medium to perform matching the difficulty of the second job to a classification of the second developer.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the management components of the disclosed subject matter.

FIG. 3 is a schematic illustrating an embodiment of an assembly line and surfaces of the disclosed subject matter.

FIG. 4 is a schematic illustrating an embodiment of the run entities of the disclosed subject matter.

FIG. 5 is a schematic of an embodiment of the disclosed system for evaluating a developer.

FIG. 6 is a schematic of an embodiment of the expert evaluation system.

FIG. 7 is a flow diagram of an embodiment of the disclosed subject matter.

FIG. 8 is a flow diagram of another embodiment of the disclosed subject matter.

FIG. 9 is a flow diagram of yet another embodiment of the disclosed subject matter.

FIG. 10 is a schematic illustrating the computing components that may be used to implement various features of embodiments described in the disclosed subject matter.

FIG. 11A is a first flow diagram of a system for allocating resources.

FIG. 11B is a second flow diagram of a system for allocating resources.

### DETAILED DESCRIPTION

The disclosed subject matter is a system, method, and computer readable storage medium for evaluating the work product for a device application. The term device application, as used herein, refers to an application that runs on an electronic device. Examples of electronic devices that may run device applications include, but are not limited to mobile phones, desktop computers, laptop computers, television sets, IoT devices, console devices such as Xbox, airline media systems, and car media players. Individuals that may work on a device application include, but are not limited to developers of code that runs a device application, designers of various aspects of the device application such as a user interface, and quality engineers who test functionality of a device application. As used herein, the term developer may refer to all such individuals.

In an exemplary embodiment, the disclosed subject matter tests new developers to establish their level of competency. For example, the disclosed evaluation system may determine a classification or rank of a new developer. An example of a rank may be a number that may range from one to three.

In an exemplary embodiment, the test includes giving a new developer a quiz, giving the new developer an assignment, and showing the new developer a video. The evaluation system may grade the quiz and assignment to determine the employee's rank or classification. The evaluation system may also factor in an employee's qualifications or experience in the employee's rank. In various embodiments, the evaluation system may rank an employee in various categories. The employee's rank may be used to assign jobs of various difficulty to the employee. For example, the evaluation system may assign a job to an employee commensurate with the employee's rank. The evaluation system may further assess completed jobs. The assessment of completed jobs may be used to refine or update the employee's rank. The assessment may be used to give employees dynamic feedback for their work product.

In various embodiments, a computing system may resolve one or more jobs based on a machine-readable specification. The term resolve, as used herein refers to a process of dividing a machine-readable specification into distinct jobs that may be completed by individuals or groups of individuals. For instance, the disclosed system may resolve one or more jobs from a machine-readable specification and determine a difficulty for each of the resolved jobs. The system may then assign the one or more resolved jobs to developers based on the rank of the developers. Once the developers complete the jobs, the evaluation system may compare the completed jobs to the machine-readable specification to determine a score or grade on the completed job. The evaluation system may further update the employee's rank based on the grade of the completed job.

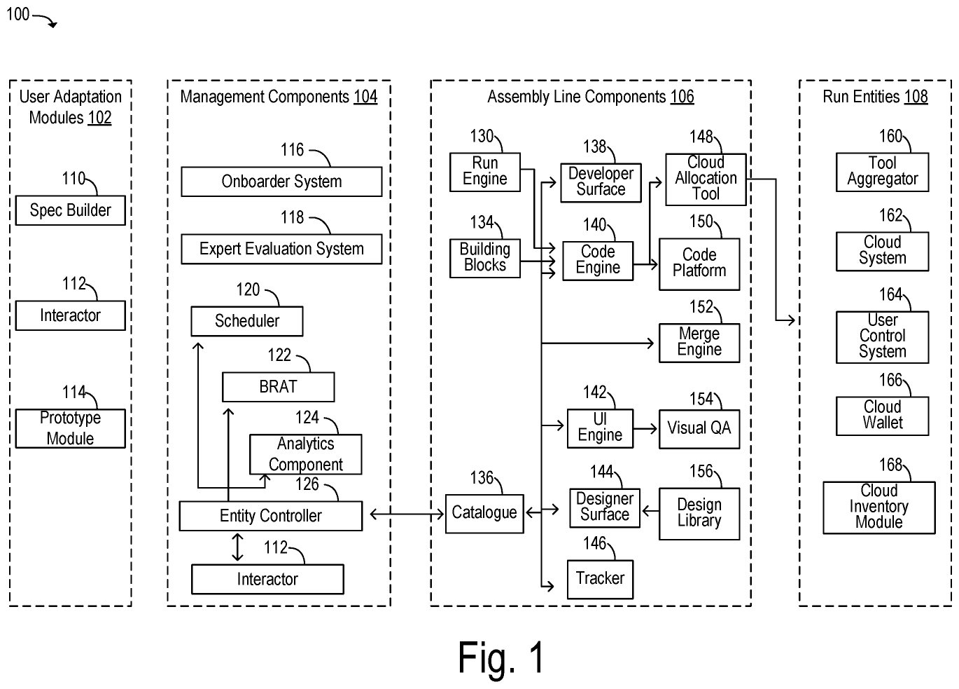

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user may leverage the various components of the software building system 100 to quickly design and complete a software project. The features of the software building system 100 operate AI algorithms where applicable to streamline the process of building software. Designing, building and managing a software project may all be automated by the AI algorithms.

To begin a software project, an intelligent AI conversational assistant may guide users in conception and design of their idea. Components of the software building system 100 may accept plain language specifications from a user and convert them into a computer readable specification that can be implemented by other parts of the software building system 100. Various other entities of the software building system 100 may accept the computer readable specification or buildcard to automatically implement it and/or manage the implementation of the computer readable specification.

The embodiment of the software building system 100 shown in FIG. 1 includes user adaptation modules 102, management components 104, assembly line components 106, and run entities 108. The user adaptation modules 102 entities guide a user during all parts of a project from the idea conception to full implementation. user adaptation modules 102 may intelligently link a user to various entities of the software building system 100 based on the specific needs of the user.

The user adaptation modules 102 may include specification builder 110, an interactor 112 system, and the prototype module 114. They may be used to guide a user through a process of building software and managing a software project. Specification builder 110, the interactor 112 system, and the prototype module 114 may be used concurrently and/or link to one another. For instance, specification builder 110 may accept user specifications that are generated in an interactor 112 system. The prototype module 114 may utilize computer generated specifications that are produced in specification builder 110 to create a prototype for various features. Further, the interactor 112 system may aid a user in implementing all features in specification builder 110 and the prototype module 114.

Specification builder 110 converts user supplied specifications into specifications that can be automatically read and implemented by various objects, instances, or entities of the software building system 100. The machine readable specifications may be referred to herein as a buildcard. In an example of use, specification builder 110 may accept a set of features, platforms, etc., as input and generate a machine readable specification for that project. Specification builder 110 may further use one or more machine learning algorithms to determine a cost and/or timeline for a given set of features. In an example of use, specification builder 110 may determine potential conflict points and factors that will significantly affect cost and timeliness of a project based on training data. For example, historical data may show that a combination of various building block components create a data transfer bottleneck. Specification builder 110 may be configured to flag such issues.

The interactor 112 system is an AI powered speech and conversational analysis system. It converses with a user with a goal of aiding the user. In one example, the interactor 112 system may ask the user a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases

In an exemplary embodiment, the NLP implemented by interactor 112 system is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation. Backpropagation is an algorithm used in neural networks to train models by adjusting the weights of the network to minimize the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP employed by the interactor 112 system may output the meaning of words and phrases that are communicated by the user. The interactor 112 system may then use the NLP output to comprehend conversational phrases and sentences to determine the relevant information related to the user's goals of a software project. Further machine learning algorithms may be employed to determine what kind of project the user wants to build including the goals of the user as well as providing relevant options for the user.

The prototype module 114 can automatically create an interactive prototype for features selected by a user. For instance, a user may select one or more features and view a prototype of the one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return best results.

The prototype module 114 may use a secondary machine learning algorithm to select a most likely starting screen for each prototype. Thus, a user may select one or more features and the prototype module 114 may automatically display a prototype of the selected features.

The software building system 100 includes management components 104 that aid the user in managing a complex software building project. The management components 104 allow a user that does not have experience in managing software projects to effectively manage multiple experts in various fields. An embodiment of the management components 104 include the onboarding system 116, an expert evaluation system 118, scheduler 120, BRAT 122, analytics component 124, entity controller 126, and the interactor 112 system.

The onboarding system 116 aggregates experts so they can be utilized to execute specifications that are set up in the software building system 100. In an exemplary embodiment, software development experts may register into the onboarding system 116 which will organize experts according to their skills, experience, and past performance. In one example, the onboarding system 116 provides the following features: partner onboarding, expert onboarding, reviewer assessments, expert availability management, and expert task allocation.

An example of partner onboarding may be pairing a user with one or more partners in a project. The onboarding system 116 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 116 to automatically review completed portions of a project. For instance, the onboarding system 116 may analyze submitted code, validate functionality of submitted code, and assess a status of the code repository. An example of expert availability management in the onboarding system 116 is to manage schedules for expert assignments and oversee expert compensation. An example of expert task allocation is to automatically assign jobs to experts that are onboarded in the onboarding system 116. For instance, the onboarding system 116 may determine a best fit to match onboarded experts with project goals and assign appropriate tasks to the determined experts.

The expert evaluation system 118 continuously evaluates developer experts. In an exemplary embodiment, the expert evaluation system 118 rates experts based on completed tasks and assigns scores to the experts. The scores may provide the experts with valuable critique and provide the onboarding system 116 with metrics with it can use to allocate the experts on future tasks.

Scheduler 120 keeps track of overall progress of a project and provides experts with job start and job completion estimates. In a complex project, some expert developers may be required to wait until parts of a project are completed before their tasks can begin. Thus, effective time allocation can improve expert developer management. Scheduler 120 provides up to date estimates to expert developers for job start and completion windows so they can better manage their own time and position them to complete their job on time with high quality.

The big resource allocation tool (BRAT 122) is capable of generating optimal developer assignments for every available parallel workstream across multiple projects. BRAT 122 system allows expert developers to be efficiently managed to minimize cost and time. In an exemplary embodiment, the BRAT 122 system considers a plethora of information including feature complexity, developer expertise, past developer experience, time zone, and project affinity to make assignments to expert developers. The BRAT 122 system may make use of the expert evaluation system 118 to determine the best experts for various assignments. Further, the expert evaluation system 118 may be leveraged to provide live grading to experts and employ qualitative and quantitative feedback. For instance, experts may be assigned a live score based on the number of jobs completed and the quality of jobs completed.

The analytics component 124 is a dashboard that provides a view of progress in a project. One of many purposes of the analytics component 124 dashboard is to provide a primary form of communication between a user and the project developers. Thus, offline communication, which can be time consuming and stressful, may be reduced. In an exemplary embodiment, the analytics component 124 dashboard may show live progress as a percentage feature along with releases, meetings, account settings, and ticket sections. Through the analytics component 124 dashboard, dependencies may be viewed and resolved by users or developer experts.

The entity controller 126 is a primary hub for entities of the software building system 100. It connects to scheduler 120, the BRAT 122 system, and the analytics component 124 to provide for continuous management of expert developer schedules, expert developer scoring for completed projects, and communication between expert developers and users. Through the entity controller 126, both expert developers and users may assess a project, make adjustments, and immediately communicate any changes to the rest of the development team.

The entity controller 126 may be linked to the interactor 112 system, allowing users to interact with a live project via an intelligent AI conversational system. Further, the Interactor 112 system may provide expert developers with up-to-date management communication such as text, email, ticketing, and even voice communications to inform developers of expected progress and/or review of completed assignments.

The assembly line components 106 comprise underlying components that provide the functionality to the software building system 100. The embodiment of the assembly line components 106 shown in FIG. 1 includes a run engine 130, building block components 134, catalogue 136, developer surface 138, a code engine 140, a UI engine 142, a designer surface 144, tracker 146, a cloud allocation tool 148, a code platform 150, a merge engine 152, Visual QA 154, and a design library 156.

The run engine 130 may maintain communication between various building block components within a project as well as outside of the project. In an exemplary embodiment, the run engine 130 may send HTTP/S GET or POST requests from one page to another.

The building block components 134 are reusable code that are used across multiple computer readable specifications. The term buildcards, as used herein, refer to machine readable specifications that are generated by specification builder 110, which may convert user specifications into a computer readable specification that contains the user specifications and a format that can be implemented by an automated process with minimal intervention by expert developers.

The computer readable specifications are constructed with building block components 134, which are reusable code components. The building block components 134 may be pretested code components that are modular and safe to use. In an exemplary embodiment, every building block component 134 consists of two sections-core and custom. Core sections comprise the lines of code which represent the main functionality and reusable components across computer readable specifications. The custom sections comprise the snippets of code that define customizations specific to the computer readable specification. This could include placeholder texts, theme, color, font, error messages, branding information, etc.

Catalogue 136 is a management tool that may be used as a backbone for applications of the software building system 100. In an exemplary embodiment, the catalogue 136 may be linked to the entity controller 126 and provide it with centralized, uniform communication between different services.

Developer surface 138 is a virtual desktop with preinstalled tools for development. Expert developers may connect to developer surface 138 to complete assigned tasks. In an exemplary embodiment, expert developers may connect to developer surface from any device connected to a network that can access the software project. For instance, developer experts may access developer surface 138 from a web browser on any device. Thus, the developer experts may essentially work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 138 further provides a secure environment for developer experts to complete their assigned tasks.

The code engine 140 is a portion of a code platform 150 that assembles all the building block components required by the build card based on the features associated with the build card. The code platform 150 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the needed throughput based on the volume of builds coming in through a queue system. This stateless architecture may also enable support for multiple languages in a plug & play manner.

The cloud allocation tool 148 manages cloud computing that is associated with computer readable specifications. For example, the cloud allocation tool 148 assesses computer readable specifications to predict a cost and resources to complete them. The cloud allocation tool 148 then creates cloud accounts based on the prediction and facilitates payments over the lifecycle of the computer readable specification.

The merge engine 152 is a tool that is responsible for automatically merging the design code with the functional code. The merge engine 152 consolidates styles and assets in one place allowing experts to easily customize and consume the generated code. The merge engine 152 may handle navigations that connect different screens within an application. It may also handle animations and any other interactions within a page.

The UI engine 142 is a design-to-code product that converts designs into browser ready code. In an exemplary embodiment, the UI engine 142 converts designs such as those made in Sketch into React code. The UI engine may be configured to scale generated UI code to various screen sizes without requiring modifications by developers. In an example of use, a design file may be uploaded by a developer expert to designer surface 144 whereby the UI engine automatically converts the design file into a browser ready format.

Visual QA 154 automates the process of comparing design files with actual generated screens and identifies visual differences between the two. Thus, screens generated by the UI engine 142 may be automatically validated by the visual QA 154 system. In various embodiments, a pixel to pixel comparison is performed using computer vision to identify discrepancies on the static page layout of the screen based on location, color contrast and geometrical diagnosis of elements on the screen. Differences may be logged as bugs by scheduler 120 so they can be reviewed by expert developers.

In an exemplary embodiment, visual QA 154 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The visual QA 154 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 144 connects designers to a project network to view all of their assigned tasks as well as create or submit customer designs. In various embodiments, computer readable specifications include prompts to insert designs. Based on the computer readable specification, the designer surface 144 informs designers of designs that are expected of them and provides for easy submission of designs to the computer readable specification. Submitted designs may be immediately available for further customization by expert developers that are connected to a project network.

Similar to building block components 134, the design library 156 contains design components that may be reused across multiple computer readable specifications. The design components in the design library 156 may be configured to be inserted into computer readable specifications, which allows designers and expert developers to easily edit them as a starting point for new designs. The design library 156 may be linked to the designer surface 144, thus allowing designers to quickly browse pretested designs for user and/or editing.

Tracker 146 is a task management tool for tracking and managing granular tasks performed by experts in a project network. In an example of use, common tasks are injected into tracker 146 at the beginning of a project. In various embodiments, the common tasks are determined based on prior projects, completed, and tracked in the software building system 100.

The run entities 108 contain entities that all users, partners, expert developers, and designers use to interact within a centralized project network. In an exemplary embodiment, the run entities 108 include tool aggregator 160, cloud system 162, user control system 164, cloud wallet 166, and a cloud inventory module 168. The tool aggregator 160 entity brings together all third-party tools and services required by users to build, run and scale their software project. For instance, it may aggregate software services from payment gateways and licenses such as Office 365. User accounts may be automatically provisioned for needed services without the hassle of integrating them one at a time. In an exemplary embodiment, users of the run entities 108 may choose from various services on demand to be integrated into their application. The run entities 108 may also automatically handle invoicing of the services for the user.

The cloud system 162 is a cloud platform that is capable of running any of the services in a software project. The cloud system 162 may connect any of the entities of the software building system 100 such as the code platform 150, developer surface 138, designer surface 144, catalogue 136, entity controller 126, specification builder 110, the interactor 112 system, and the prototype module 114 to users, expert developers, and designers via a cloud network. In one example, cloud system 162 may connect developer experts to an IDE and design software for designers allowing them to work on a software project from any device.

The user control system 164 is a system requiring the user to have input over every feature of a final product in a software product. With the user control system 164, automation is configured to allow the user to edit and modify any features that are attached to a software project regardless as to the coding and design by developer experts and designer. For example, building block components 134 are configured to be malleable such that any customizations by expert developers can be undone without breaking the rest of a project. Thus, dependencies are configured so that no one feature locks out or restricts development of other features.

Cloud wallet 166 is a feature that handles transactions between various individuals and/or groups that work on a software project. For instance, payment for work performed by developer experts or designers from a user is facilitated by cloud wallet 166. A user need only set up a single account in cloud wallet 166 whereby cloud wallet handles payments of all transactions.

A cloud allocation tool 148 may automatically predict cloud costs that would be incurred by a computer readable specification. This is achieved by consuming data from multiple cloud providers and converting it to domain specific language, which allows the cloud allocation tool 148 to predict infrastructure blueprints for customers' computer readable specifications in a cloud agnostic manner. It manages the infrastructure for the entire lifecycle of the computer readable specification (from development to after care) which includes creation of cloud accounts, in predicted cloud providers, along with setting up CI/CD to facilitate automated deployments.

The cloud inventory module 168 handles storage of assets on the run entities 108. For instance, building block components 134 and assets of the design library are stored in the cloud inventory entity. Expert developers and designers that are onboarded by onboarding system 116 may have profiles stored in the cloud inventory module 168. Further, the cloud inventory module 168 may store funds that are managed by the cloud wallet 166. The cloud inventory module 168 may store various software packages that are used by users, expert developers, and designers to produce a software product.

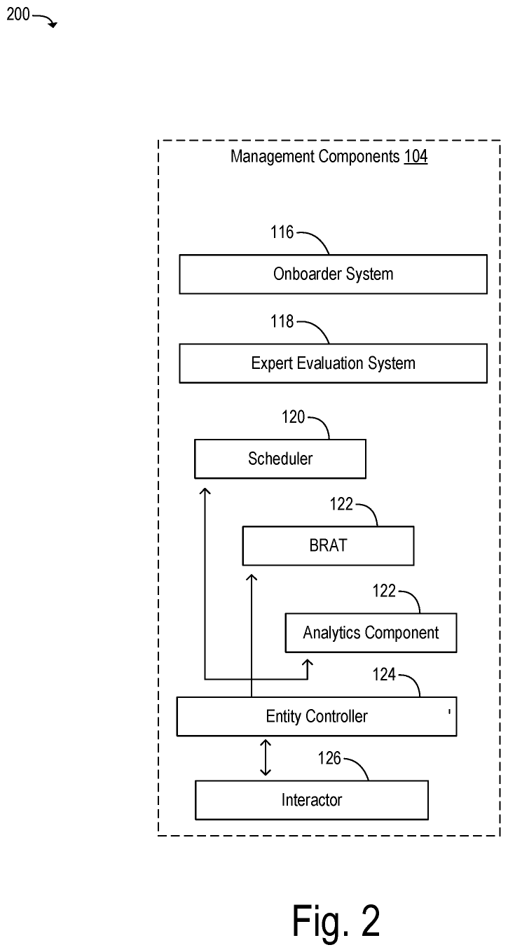

Referring to FIG. 2, FIG. 2 is a schematic 200 illustrating an embodiment of the management components 104 of the software building system 100. The management components 104 provide for continuous assessment and management of a project through its entities and systems. The central hub of the management components 104 is entity controller 126. In an exemplary embodiment, core functionality of the entity controller 126 system comprises the following: display computer readable specifications configurations, provide statuses of all computer readable specifications, provide toolkits within each computer readable specification, integration of the entity controller 126 with tracker 146 and the onboarding system 116, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all computer readable specifications may be displayed on the entity controller 126, which provides a concise perspective of the status of a software project. Toolkits provided in each computer readable specification allow expert developers and designers to chat, email, host meetings, and implement 3rd party integrations with users. Entity controller 126 allows a user to track progress through a variety of features including but not limited to tracker 146, the UI engine 142, and the onboarding system 116. For instance, the entity controller 126 may display the status of computer readable specifications as displayed in tracker 146. Further, the entity controller 126 may display a list of experts available through the onboarding system 116 at a given time as well as ranking experts for various jobs.

The entity controller 126 may also be configured to create code repositories. For example, the entity controller 126 may be configured to automatically create an infrastructure for code and to create a separate code repository for each branch of the infrastructure. Commits to the repository may also be managed by the entity controller 126.

Entity controller 126 may be integrated into scheduler 120 to determine a timeline for jobs to be completed by developer experts and designers. The BRAT 122 system may be leveraged to score and rank experts for jobs in scheduler 120. A user may interact with the various entity controller 126 features through the analytics component 124 dashboard. Alternatively, a user may interact with the entity controller 126 features via the interactive conversation in the interactor 112 system.

Entity controller 126 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 126. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

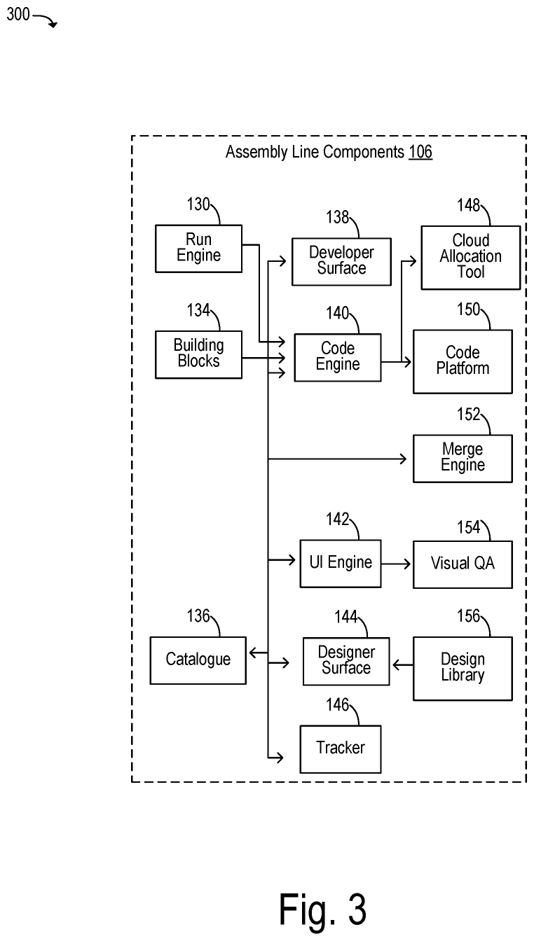

Referring to FIG. 3, FIG. 3 is a schematic 300 illustrating an embodiment of the assembly line components 106 of the software building system 100. The assembly line components 106 support the various features of the management components 104. For instance, the code platform 150 is configured to facilitate user management of a software project. The code engine 140 allows users to manage the creation of software by standardizing all code with pretested building block components. The building block components contain LSTs that identify the customizable portions of the building block components 134.

The machine readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The scheduler 120 may hire the expert developers based on the computer readable specifications or with direction from the user. Similarly, one or more designers may be hired based on specifications in a computer readable specification. Users may actively participate in management or take a passive role.

A cloud allocation tool 148 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 138 system provides an easy to set up platform within which expert developers can work on a software project. For instance, a developer in any geography may connect to a project via the cloud system 162 and immediately access tools to generate code. In one example, the expert developer is provided with a preconfigured IDE as they sign into a project from a web browser.

The designer surface 144 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 156. The design components, like building block components, allow the designers to start a design from a standardized design that is already functional.

The UI engine 142 may automatically convert designs into web ready code such as React code that may be viewed by a web browser. To ensure that the conversion process is accurate, the visual QA 154 system may evaluate screens generated by the UI engine 142 by comparing them with the designs that the screens are based on. In an exemplary embodiment, the visual QA 154 system does a pixel to pixel comparison and logs any discrepancies to be evaluated by an expert developer.

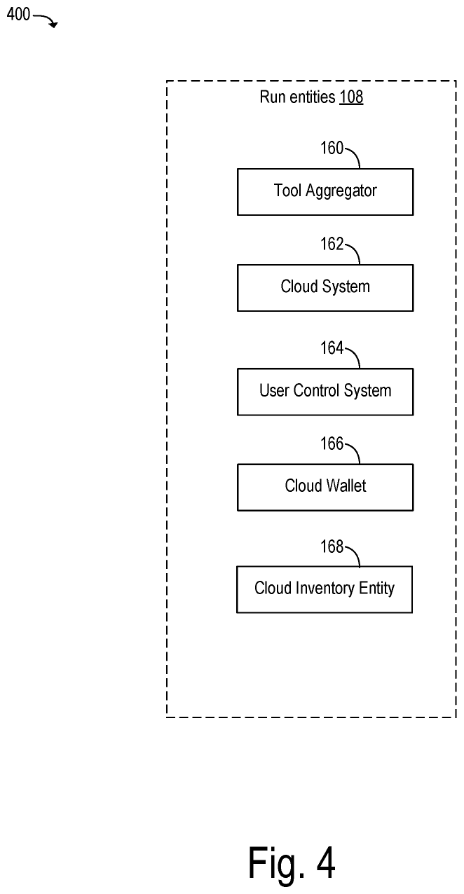

Referring to FIG. 4, FIG. 4 is a schematic 400 illustrating an embodiment of the run entities 108 of the software building system. The run entities 108 provides a user with 3^{rd} party tools and services, inventory management, and cloud services in a scalable system that can be automated to manage a software project. In an exemplary embodiment, the run entities 108 is a cloud-based system that provides a user with all tools necessary to run a project in a cloud environment.

For instance, the tool aggregator 160 automatically subscribes with appropriate 3^{rd} party tools and services and makes them available to a user without a time consuming and potentially confusing set up. The cloud system 162 connects a user to any of the features and services of the software project through a remote terminal. Through the cloud system 162, a user may use the user control system 164 to manage all aspects of a software project including conversing with an intelligent AI in the interactor 112 system, providing user specifications that are converted into computer readable specifications, providing user designs, viewing code, editing code, editing designs, interacting with expert developers and designers, interacting with partners, managing costs, and paying contractors.

A user may handle all costs and payments of a software project through cloud wallet 166. Payments to contractors such as expert developers and designers may be handled through one or more accounts in cloud wallet 166. The automated systems that assess completion of projects such as tracker 146 may automatically determine when jobs are completed and initiate appropriate payment as a result. Thus, accounting through cloud wallet 166 may be at least partially automated. In an exemplary embodiment, payments through cloud wallet 166 are completed by a machine learning AI that assesses job completion and total payment for contractors and/or employees in a software project.

Cloud inventory module 168 automatically manages inventory and purchases without human involvement. For example, cloud inventory module 168 manages storage of data in a repository or data warehouse. In an exemplary embodiment, it uses a modified version of the knapsack algorithm to recommend commitments to data that it stores in the data warehouse. Cloud inventory module 168 further automates and manages cloud reservations such as the tools providing in the tool aggregator 160.

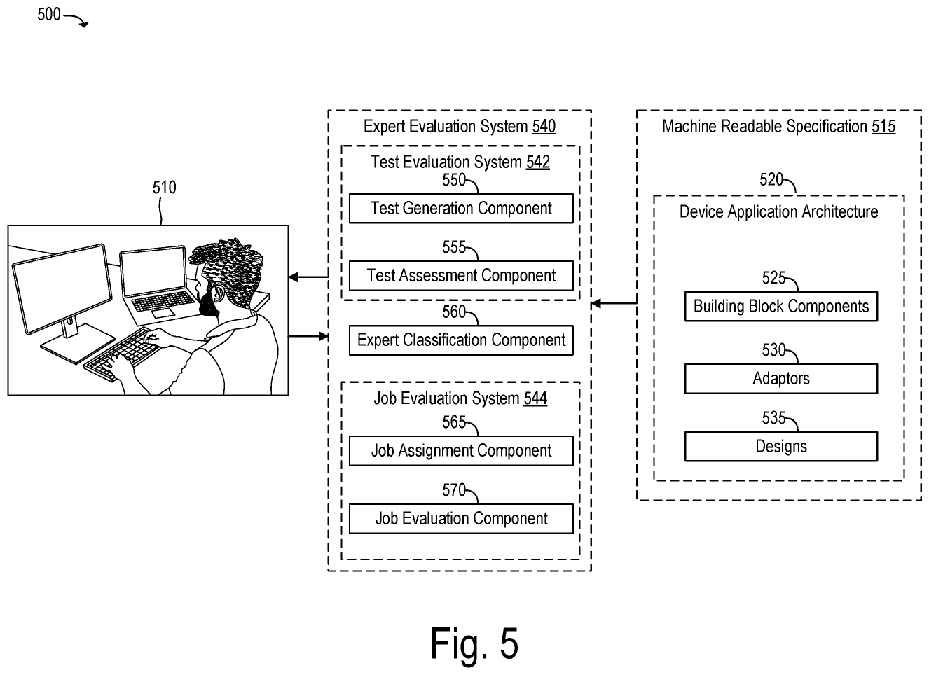

Referring to FIG. 5, FIG. 5 is a schematic 500 of an embodiment of the disclosed system for evaluating a developer 510. The developer 510 may be any individual that contributes to the development of a device application. The developer 510 may be a software developer, a designer, a quality engineer, or the like. The disclosed system may be used to classify one or more developers that are working on a device application. The classification may be used to assess the quality of work that employees are capable of performing. In various embodiments, the classification may be further used to match employees or developers to jobs that they are capable of performing.

In various embodiments, the disclosed subject matter may include a machine readable specification 515 for a device application. The machine-readable specification 515 may include information necessary to define one or more jobs that can be performed by the developer to contribute to the device application. For instance, the machine-readable specification 515 may include details necessary to build a building block component for the device application.

The disclosed system may include an expert evaluation system 540 that is capable of evaluating a developer 510 and evaluated jobs completed by the developer 510. In the exemplary embodiment shown in the schematic 500, the expert evaluation system 540 includes a test evaluation system 542, an expert classification component 560, and a job evaluation system 544.

The test evaluation system 542 may be used to test a developer 510 to determine the developer's 510 ability level. For instance, the test evaluation system 542 may give the developer 510 one or more tests for the developer to complete. Once completed, the test evaluation system 542 may grade the one or more tests to classify the developer 510. The test evaluation system 542 may include a test generation component 550 and a test assessment component 555. The test generation component 550 may be configured to generate one or more tests for the developer 510. In an exemplary embodiment, the test generation component 550 may generate one or more quizzes based on a developer's experience. The developer's experience may be determined based on a resume, an interview with the developer, or the like. An example of a quiz may be a test comprising one or more questions for which there is at least one correct answer. In addition to quizzes, the test generation component 550 may generate one or more assignments for the developer. An example of an assignment may be a task to complete a building block component. Another example of an assignment may be a task to design a user interface for a screen. Another example of a task may be to quality test a device application. An assignment for a developer that is a quality engineer may include conducting an analysis of a device application to identify defects or bugs in the device application. Another assignment for a developer that is a quality engineer may include making one or more improvements to a functionality of a device application or portion of a device application.

The test evaluation system 542 may transmit one or more quizzes or assignments that are generated by the test generation component 550 to the developer 510 for the developer to complete. Once completed, the developer 510 may transmit the completed quiz or assignment back to the test evaluation system 542. The test assessment component 555 may evaluate the completed quiz or assignment to determine a score or rank for the developer 510. For example, the test assessment component 555 may determine whether the developer 510 answered questions in the one or more quizzes correctly. In addition to grading quizzes, the test assessment component 555 may also evaluate assignments that are completed by the developer 510. For example, the test assessment component 555 may evaluate a completed assignment for various criteria to determine a score for the completed assignment. For instance, the test assessment component 555 may use a machine learning algorithm to evaluate a quality of an assignment to develop a software component or device application. An example of a machine learning algorithm is a neural network. In the example given above, the machine learning algorithm may evaluate a structure of the completed assignment to determine whether the structure conforms to standard industry practice. For instance, the machine learning algorithm may evaluate whether the developer 510 adhered to an entity component pattern that was called for in the assignment. The machine learning algorithm may further evaluate output based on various input for the completed assignment. For instance, if the assignment was to develop a component that accepts one or more user logins and sorts them into a database, the machine learning algorithm may test the completed component with one or more user logins to determine whether the completed assignment works properly.

The test assessment component 555 may generate a score that may be used by an expert classification component 560 to determine a classification or rank of the developer 510. The expert classification component 560 may use any combination of quiz scores and assignment scores to determine a classification for the developer 510. In various embodiments, the expert classification component 560 may weight one or more quizzes or assignments based on various criteria. For instance, the expert classification component 560 may weight a quiz that is related to a developers 510 expertise more than other quizzes or assignments. In another example, the expert classification component 560 may weight one or more quizzes or one or more assignments based on jobs that are available from the machine-readable specification 515. For instance, the expert classification component 560 may weight quizzes or assignments related to databases if there are pending jobs that require database work. A pending job may be a job that is yet to be completed. The term “pending machine readable specification”, as used herein, is a machine readable specification that includes one or more pending jobs.

The job evaluation system 544 transmits jobs to the developer 510 and assesses completed jobs that are received from the developer 510. In an exemplary embodiment, the job evaluation system 544 may include a job assignment component 565 and a job evaluation component 570. The job assignment component 565 may accept one or more jobs based on a machine-readable specification 515. In an exemplary embodiment, the machine-readable specification 515 may include one or more building block components 525, one or more adapters 530 that are designed to link the building block components 525, and one or more designs 535 for a device application. Additionally, the machine-readable specification 515 may include a device application architecture 520 that defines a structure for the building block components 525, the adapters 530, and designs 535.

One or more jobs may be resolved from the machine-readable specification 515. The jobs may be then passed by the job assignment component 565 to a developer 510 to be completed. Once completed, the developer 510 may transmit the completed job back to the job evaluation system 544. The job evaluation component 570 may assess the quality of the completed job. In an exemplary embodiment, the job evaluation component 570 comprises a machine learning algorithm that is configured to evaluate completed jobs. In various embodiments, different machine learning algorithms or models may be configured based on a type of job. For example, a machine learning algorithm may be configured to evaluate completed user interface components for device applications. For instance, a job to develop a building block component 525 that allows a user to select one or more items for purchase on a device application may be assigned to a developer 510. Once the job is completed, the job evaluation component 570 may evaluate the completed job using a machine learned algorithm that is trained to evaluate components related to user input.

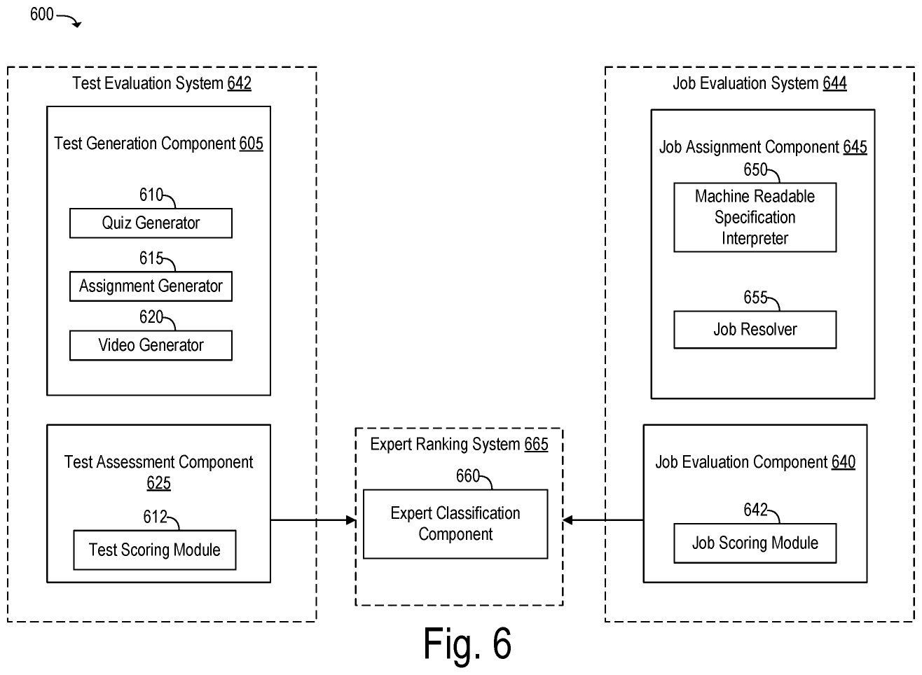

Referring to FIG. 6, FIG. 6 is a schematic of an embodiment of the expert evaluation system 600. The expert evaluation system 600 may be used to score or classify developers that work on various aspects of a device application. In an exemplary embodiment that is shown in FIG. 6, the expert evaluation system 600 includes a test evaluation system 642, an expert ranking system 665, and a job evaluation system 644. The test evaluation system 642 generates tests for developers 510 and grades tests once they are completed by developers 510. In an example embodiment, the test evaluation system 642 includes a test generation component 605 and a test assessment component 625.

The test generation component 605 generates quizzes, assignments, and/or videos for the developer 510. In an exemplary embodiment, the test generation component 605 may include a video generator 620 that generates videos for the developer 510 to view. The videos may be educational or part of the test. For example, the video generator 620 may generate one or more videos based on a content of quizzes or assignments that will be transmitted to the developer 510. For example, a video generator 620 may generate a video that includes a code structure tutorial for the developer 510 to view before working on an assignment. Accordingly, the developer 510 could be tasked to adhere to a structure based on the video as the developer 510 works on the assignment.

The quiz generator 610 may generate quizzes for developers 510. In an exemplary embodiment, quiz questions are selected based on the experience level of the developer 510. For example, if the developer's resume shows expert level experience in using cloud platforms, the quiz generator 610 may test the developer's 510 experience with questions related to cloud providers such as AWS and Azure. In another example, the quiz generator 610 may generate quiz questions based on pending jobs. For example, the quiz generator 610 may generate a ratio of quiz questions based on the ratio of job types that are pending. An example ratio of job types may comprise 30% of jobs related to SQL databases. Accordingly, the quiz generator 610 may generate questions related to SQL databases for approximately 30% of the questions on the quiz.

The assignment generator 615 may generate assignments for the developer 510 that can be graded by the test assessment component 625. The assignment generator 615 may be configured to generate assignments that are capable of being graded or scored. For instance, the assignment generator 615 may generate assignments directing a developer to produce a component that performs a specific function based on specific input. For example, the assignment generator, 615 may direct a developer 510 to produce a component that interacts with a bank API to perform a transaction. Accordingly, the test scoring module 612 of the test assessment component 625 may be capable of verifying a correct output of the component based on the bank API of the assignment. In various embodiments, the assignment generator 615 may be configured to assign a developer 510 assignments that are related to the developer's experience.

The test assessment component 625 may grade completed quizzes and completed assignments with the test scoring module 612 to determine a score for the developer 510. In various embodiments, the test scoring module 612 comprises a machine learning algorithm that is trained to grade quizzes and/or assignments. Various machine learning algorithms may be used for the test scoring module 612. In an exemplary embodiment, the machine learning algorithm is a neural network that uses natural language processing to analyze completed assignments and determine a quality of the completed assignment. Thus, completed quizzes and assignments may be assigned a score that is passed on to the expert ranking system 665. The expert ranking system 65 may pass scores through the expert classification component 660 to determine a rank or classification of the developer 510 based on scores determined by the test assessment component 625. In an exemplary embodiment, the expert classification component 660 classifies a developer 510 as one of either beginner, intermediate, or expert. In various embodiments, the expert classification component 660 determines a classification for each developer in multiple areas. For instance, a developer 510 may be classified as intermediate in relational databases and classified as a beginner in NoSQL databases.

The job evaluation system 644 assigns jobs to developers and evaluates completed jobs from developers 510. The job evaluation system 644 may include a job assignment component 645 and a job evaluation component 640. The job assignment component 645 may determine one or more jobs from a machine-readable specification to be assigned to a developer 510. The job evaluation component 640 may assess completed jobs to determine a score that is passed to the expert ranking system 665.

The job assignment component 645 may include a machine readable specification interpreter 650 and a job resolver 655. The machine-readable specification interpreter may be configured to extract all related information from machine-readable specifications. For instance, the machine readable specification interpreter 650 may extract information related to one or more components, designs, and adapters. The job resolver 655 may determine one or more jobs based on the components, designs, and adapters specified in the machine-readable specification. In an exemplary embodiment, the job resolver 655 may resolve jobs based on links between components as defined by the machine-readable specification. In various embodiments, the machine-readable specification may define links between various features and components in the device application. The job resolver may select one or more components based on the links. In one example, the job resolver may resolve a job to develop two components that communicate with one another. An example of components that communicate with one another comprises a first component that generates a message that is transmitted through the run engine and received by a second component.

In various embodiments, the job resolver 655 may determine a difficulty of the job. For example, the job resolver 655 may comprise a machine learning algorithm that is configured to determine a difficulty of a job. The machine learning algorithm may be trained, for example, on difficulties of previous jobs. In one example, the difficulty may be determined based on an amount of work to be performed for a job. An amount of work may be correlated to a number of linkages between components for a job to complete a building block component. For example, a building block component that is linked to two or more other building block components may be classified as expert level difficulty. A building block component that is linked to one other building block component may be classified as an intermediate difficulty. And a building block component that has no links to other building block components may be classified as a beginner level difficulty.

Once a developer 510 completes a job, the completed job is passed to the job evaluation component 640. The job scoring module 642 may assign a score to the completed job based on a quality of the completed job. In an exemplary embodiment, the job scoring module may use a machine learning algorithm to analyze the completed job to determine the quality of the job. For example, the job scoring module may use a neural network that makes use of natural language processing to assess code that is submitted by the developer to develop a building block component for a device application. In another example, the job scoring module 642 may use a neural network to analyze a design for a user interface. For instance, the neural network may be trained to determine a score for various types of designs such as hero images, navigation menus, car layouts, and modal window designs. In one example, the neural network may be configured to evaluate a hero image based on an L-shaped pattern whereby interactive portions of the image are limited to two adjacent sides of the screen. The job scoring module 642 may output a score that may be evaluated by the expert ranking system 665 to determine a rank or update the rank/classification for the developer 510.

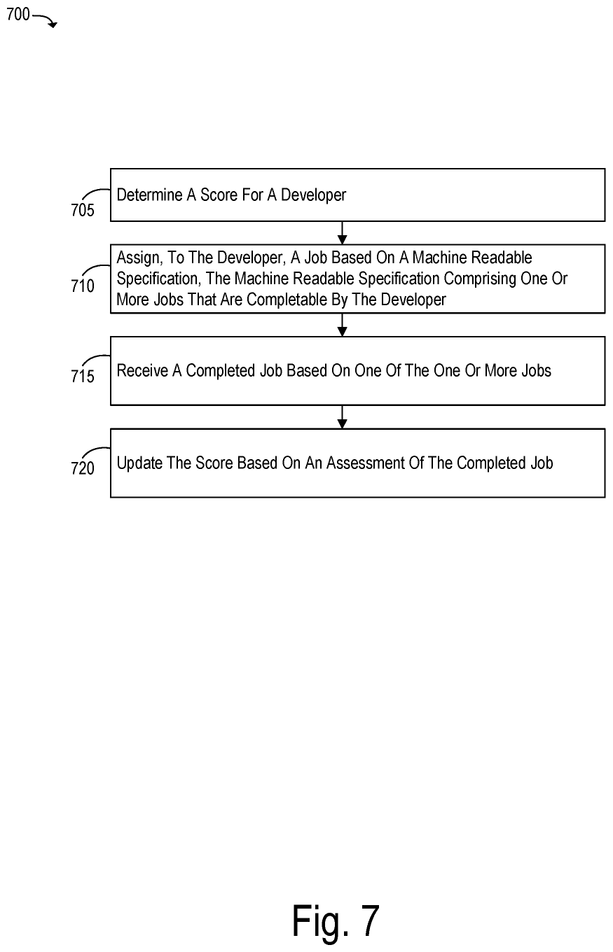

Referring to FIG. 7, FIG. 7 is a flow diagram 700 of an embodiment of the disclosed subject matter. The process shown in the flow diagram 700 may be used to evaluate or assess new developers for a device application. Further, the process may be used to provide live feedback on work product that is produced by a developer 510. At step 705, the process may determine a score for a developer 510. In an exemplary embodiment, the test evaluation system 542 may generate a test that is transmitted to the developer 510. Once the developer completes the test, the test may be graded by the test assessment component 555 to determine a score. The expert classification component 560 may classify the developer based on the score. An example of a classification may be a rank of 1-3 or a classification of one of beginner, intermediate, and advanced.

At step 710, the process may assign, to the developer, a job based on a machine-readable specification where the machine-readable specification includes one or more jobs that are completable by the developer 510. In various embodiments, the job resolver 655 may resolve one or more jobs from the machine-readable specification. In an exemplary embodiment, the job resolver 655 further determines a difficulty for the job. For example, the job resolver 655 may determine a difficulty between 1 and 10 for the job. The job may be assigned to the developer 510 based on the difficulty and the classification of the developer 510. For instance, a job that has a high difficulty may be assigned to a developer with a high rank or classification. Likewise, a developer with a classification of beginner may be assigned jobs that have low difficulty.

At step 715, the process may receive a completed job based on one of the one or more jobs. For example, a developer 510 may complete a job and submit it back to the job evaluation system. The job evaluation system 544 may then evaluate the job to determine a quality of the job. For example, the completed job may be assigned a score based on an evaluation by a machine learning algorithm that is trained based on previously completed jobs.

At step 720, the process may update the score based on an assessment of the completed job. Thus, the developer's classification may be modified or updated based on a score determined by the job evaluation system 544. For example, an expert-ranked developer 510 that receives a low score for a completed job may be downgraded to an intermediate-ranked developer 510. Similarly, a developer may increase in rank or classification based on a high-quality job.

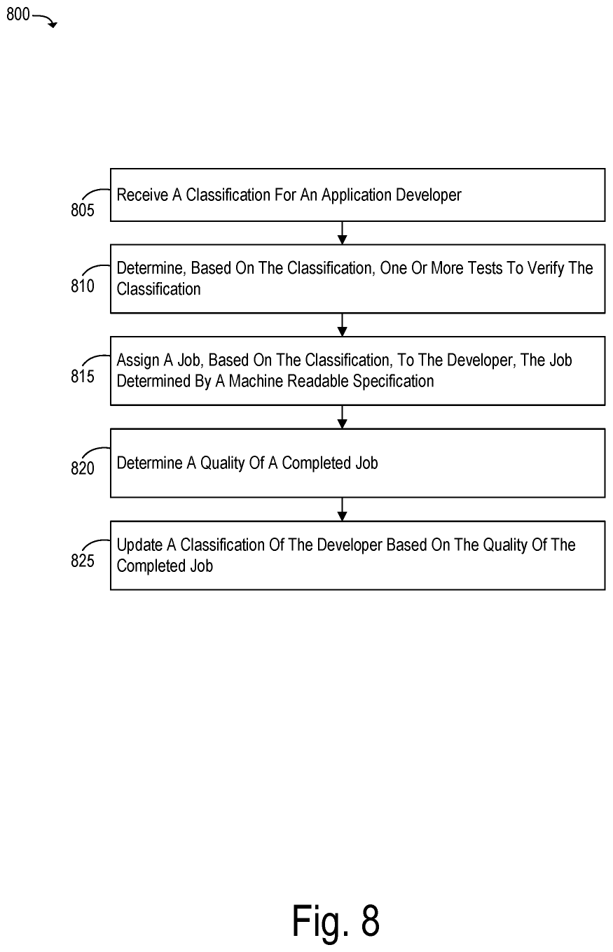

Referring to FIG. 8, FIG. 8 is a flow diagram 800 of another embodiment of the disclosed subject matter. At step 805, the process may receive a classification for an application developer. The application developer may be a software developer, designer, quality engineer, or the like. In an exemplary embodiment, the classification may be given by the application developer. In another example, the classification may be determined by an analysis of the application developer's resume. In another example, the classification is received from a computing system.

At step 810, the process may determine, based on the classification, one or more tests to verify the classification. For example, the one or more tests may be generated by the test generation component 550 and graded by the test assessment component 555. The expert classification component 560 may convert a score, which was determined by the test assessment component 555, to determine a classification based on the test. The determined classification may be compared to the classification received at step 805 to verify the received classification.

At step 815, the process may assign a job, based on the classification, to the developer, where the job is determined by a machine-readable specification. In an exemplary embodiment, the job assignment component 645 may determine one or more jobs from a machine-readable specification. The job resolver 655 of the job assignment component 645 may determine a difficulty of the job and match the difficulty of the job to the classification of the application developer.

At step 820, the process may determine a quality of the completed job. The completed job may be based on the job that was assigned to the application developer at step 815. The job evaluation system 544 may evaluate the completed job and assign a score based on its quality. In various embodiments, the completed job may be evaluated using a machine learning algorithm. At step 825, the process may update a classification of the application developer based on the quality of the completed job.

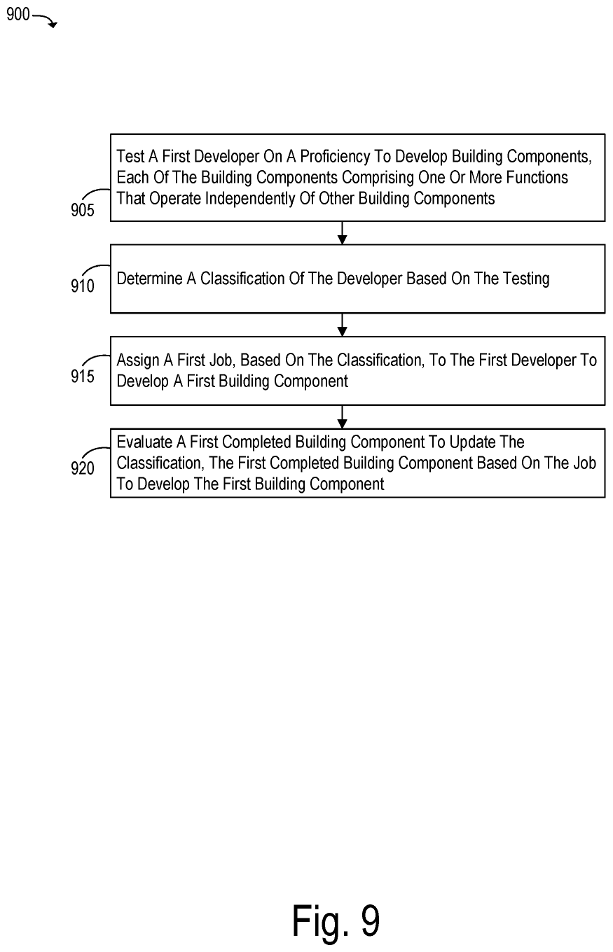

Referring to FIG. 9, FIG. 9 is a flow diagram 900 of yet another embodiment of the disclosed subject matter. At step 905, the process may test a first developer on a proficiency to develop building components where each of the building components includes one or more functions that operate independently of other building components. The building components may be building block components for a device application. The test may be generated by the test evaluation system 542. In an example of a test, the test generation component 550 may generate a quiz with one or more questions relating to the structure and function of the building block component. The test generation component 550 may further generate one or more assignments to test the developer on their ability to develop building block components.

The term function, as used herein, refers to any block of code that performs a specific task or set of tasks. The term function may refer to, subroutines, classes, components, lambda functions, callbacks, and the like.

At step 910, the process may determine a classification of the developer based on the testing. The test assessment component may grade the test to determine a score. In an exemplary embodiment, the test assessment component 555 may use a machine learning algorithm, that is trained on previous test scores, to score the assignment. The score may be passed to the expert classification component to rank the developer. In an exemplary embodiment, the developer may be ranked one of either beginner, intermediate, or expert.

At step 915, the process may assign a first job, based on the classification, to the first developer to develop a first building component. The job evaluation system 544 may resolve one or more jobs from a machine-readable specification 515. Further, the job evaluation system 544 may determine a difficulty for each of the resolved jobs. The process may assign one or more jobs to the developer based on the difficulty of the job and the classification of the developer. For instance, difficult jobs would be assigned to a developer with a high classification and vice versa.

At step 920, the process may evaluate a first completed building component to update the classification where the first completed building component is based on the job to develop the first building component. After being assigned the job, the developer may complete the job and submit it back to the expert evaluation system 540. The job evaluation component 570 may determine a score of the completed job based on a quality of the job. The score may be passed to the expert classification component 560 to update the classification of the developer.

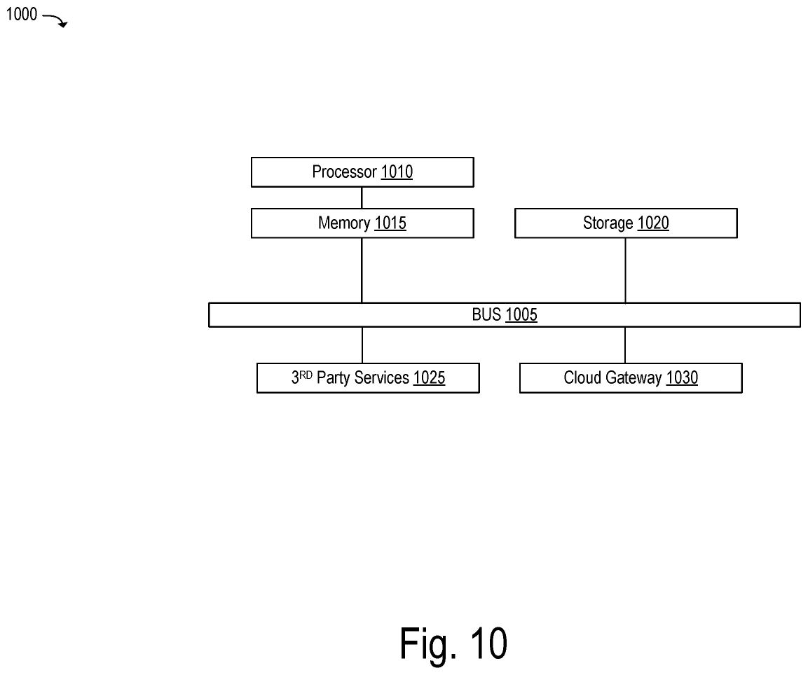

Referring to FIG. 10, FIG. 10 is a schematic illustrating a computing system 1000 that may be used to implement various features of embodiments described in the disclosed subject matter. The terms components, entities, modules, surface, and platform, when used herein, may refer to one of the many embodiments of a computing system 1000. The computing system 1000 may be a single computer, a co-located computing system, a cloud-based computing system, or the like. The computing system 1000 may be used to carry out the functions of one or more of the features, entities, and/or components of a software project.

The exemplary embodiment of the computing system 1000 shown in FIG. 10 includes a bus 1005 that connects the various components of the computing system 1000, one or more processors 1010 connected to a memory 1015, and at least one storage 1020. The processor 1010 is an electronic circuit that executes instructions that are passed to it from the memory 1015. Executed instructions are passed back from the processor 1010 to the memory 1015. The interaction between the processor 1010 and memory 1015 allow the computing system 1000 to perform computations, calculations, and various computing to run software applications.

Examples of the processor 1010 include central processing units (CPUs), graphics processing units (GPUs), field programmable gate arrays (FPGAs), complex programmable logic devices (CPLDs), and application specific integrated circuits (ASICs). The memory 1015 stores instructions that are to be passed to the processor 1010 and receives executed instructions from the processor 1010. The memory 1015 also passes and receives instructions from all other components of the computing system 1000 through the bus 1005. For example, a computer monitor may receive images from the memory 1015 for display. Examples of memory include random access memory (RAM) and read only memory (ROM). RAM has high speed memory retrieval and does not hold data after power is turned off. ROM is typically slower than RAM and does not lose data when power is turned off.

The storage 1020 is intended for long term data storage. Data in the software project such as computer readable specifications, code, designs, and the like may be saved in a storage 1020. The storage 1020 may be stored at any location including in the cloud. Various types of storage include spinning magnetic drives and solid-state storage drives.

The computing system 1000 may connect to other computing systems in the performance of a software project. For instance, the computing system 1000 may send and receive data from 3^{rd} party services such as Office 365 and Adobe. Similarly, users may access the computing system 1000 via a cloud gateway 1030. For instance, a user on a separate computing system may connect to the computing system 1000 to access data, interact with the run entities 108, and even use 3^{rd} party services 1025 via the cloud gateway.

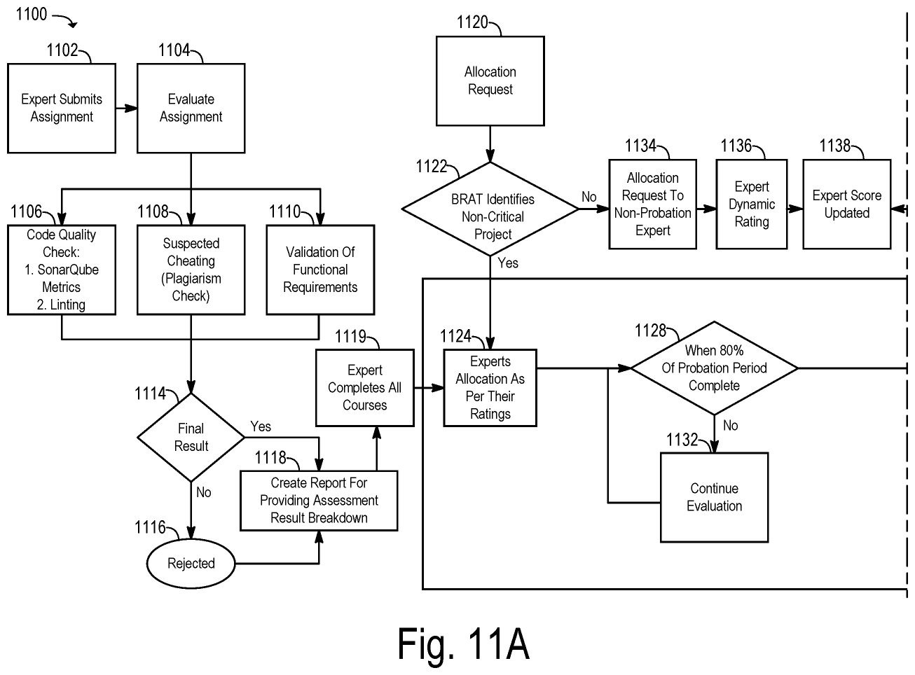

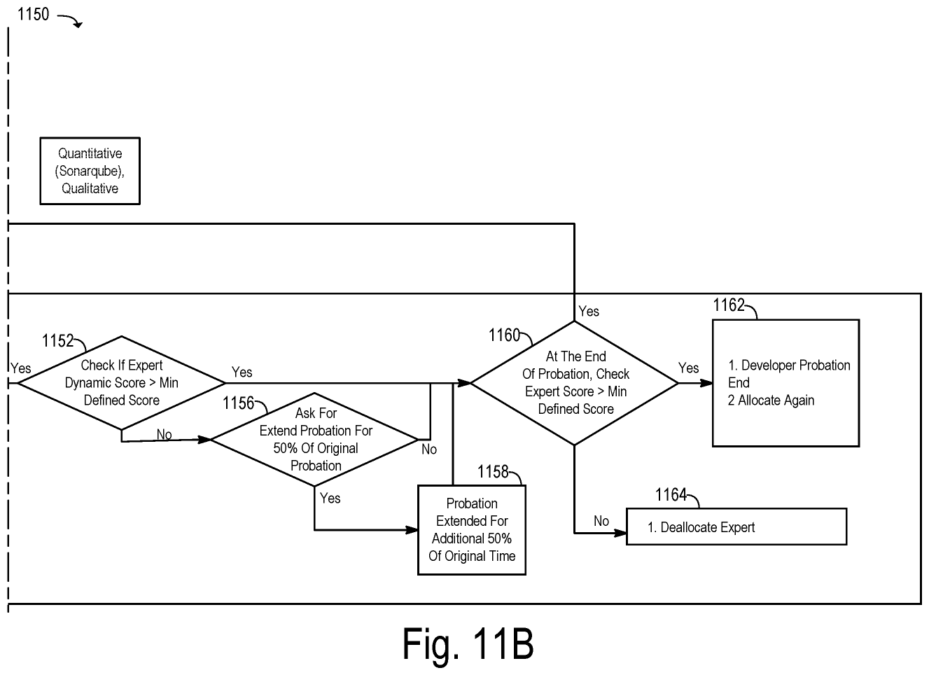

Referring to FIGS. 11A-11B, FIGS. 11A-11B together show portions of a single flow diagram of an embodiment of the disclosed system for allocating resources to develop a device application. FIG. 11A shows a first flow diagram 1100 of a system for allocating resources. The system for allocating resources may select one or more developer resources to work on a job to contribute to generation of a device application. Various jobs may include, but are not limited to developing a building block component, designing an interface, and testing a quality of the device application. In various embodiments, the system for allocating resources may receive one or more jobs from the job resolver 655 and determine the optimal developer(s) to complete each job. The system for allocating resources may further automatically contact the developer and manage the timing at which jobs are completed.

At step 1102, an expert submits an assignment to the system. In various embodiments, the assignment is received by the test evaluation system 642. At step 604, the test assessment component 625 may evaluate the assignment to determine a score for the assignment.

In the exemplary embodiment shown in FIG. 11A, the test assessment component 555 may perform a variety of checks on the assignment. The type of check may depend on the type of work that was performed for the job. For example, a job to develop a new component may be checked according to the steps shown in the first flow diagram 1100. At step 1106, the test assessment component 555 may check a quality of a development code. An exemplary embodiment the quality may be checked by analyzing SonarQube metrics and linting the code. Both the SonarQube metrics and linting are ways to check code for various errors and conforming to various standards. Further, at step 1108, the test assessment component 555 may do a plagiarism check on the submitted code. And at step 1110, the test assessment component 555 may validate the functional requirements of the code. The functional requirements may be verified by a machine learned algorithm that analyzes the completed assignment. At step 1114, the test assessment component 555 may determine a final score for the assignment. If the score doesn't meet a minimum threshold, the assignment will be rejected at step 1116. At step 1118, the system may create a report providing a breakdown of the score. And at step 1119, the system may determine whether the developer completed all courses and including tests and assignments. In various embodiments, a developer may be required to complete a minimum number of courses or assignments including quizzes, tests, or the like before being verified to work on a job. In an exemplary embodiment, developers that complete around of courses will be placed on probation whereby they are further evaluated based on completed job assignments.

At step 1120, the system for allocating resources may receive an allocation request to complete one or more tasks related to generating a device application. At step 1122, the big resource allocation tool may determine whether the allocation request is related to a noncritical project. A noncritical project may be any project that has a low priority. In an exemplary embodiment only projects that are noncritical are low priority. If the job is determined to be noncritical, a developer or expert that is on probation may be considered for the job. If the job is considered to be critical however, only non-probation developers are considered.

At step 1134, the system for allocating resources may allocate a job based on the allocation request to a non-probation developer. The job may be determined by the job resolver 655 by interpreting a machine-readable specification. Once the developer completes the job, the job may be evaluated by the job evaluation component 570 at step 1136. At step 1138, the score determined by the job evaluation component 570 is updated.

At step 1124, where it the system determined that an allocation request was noncritical, probationary and non-probationary developers may be considered. The classification or score of the developers may be considered to assign their job. In various embodiments developers that are on probation are assigned jobs that are one rank lower than their classification. For example, a developer that is on probation may be assigned jobs that have a difficulty that is below their level of classification. At step 1128, a probationary period is tracked for the developer that if the developer is in a probationary period. An exemplary embodiment, the probationary period may be for an amount of time, a number of projects, or combination thereof. In the embodiment shown in the first flow diagram 1100, developers that are within their probationary period are continually evaluated at step 1132 until they reach 80% of their probation period.

Referring to FIG. 11B, FIG. 11B shows a second flow diagram 1150 of a system for allocating resources. In the exemplary embodiment where the probationary developer has reached 80% of their probationary period and step 1132, the system for allocating resources may check if their score meets a minimum threshold at step 1152. The minimum threshold may be set to any arbitrary number that represents a minimum level of expertise required for the developer. If the developer does not meet the minimum threshold, the probation period may be extended for an amount of time. In the exemplary embodiment shown in the second flow diagram 1150, the probationary period may be extended by 50% at step 1158 based on a request at step 1156.

At step 1160, the system for allocating resources may determine whether the developer's score meets a minimum threshold. If the score does meet the minimum threshold, the developer's probation will end at step 1162 and the developer's rating will be updated at step 1138. If the developer does not meet the minimum threshold, the developer may be the deallocated and not considered for further jobs at step 1164.

Many variations may be made to the embodiments of the software project described herein. All variations, including combinations of variations, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A method for developing a building component for a device application: the method comprising:
testing a first developer on a proficiency to develop building components, each of the building components comprising one or more functions that operate independently of other building components;
determining a classification of the developer based on the testing;
assigning a first job, based on the classification, to the first developer to develop a first building component; and
evaluating a first completed building component to update the classification, the first completed building component based on the job to develop the first building component.

2. The method of claim 1, wherein the evaluating comprises verifying that the first completed building component comprises functions that operate independently of other building components.

3. The method of claim 2, further comprising:
assigning a second job to a second developer to develop a second building component; and
evaluating a second completed building component that is based on the second building component.

4. The method of claim 3, further comprising building a device application with the completed first building component and the completed second building component.

5. The method of claim 4, wherein assigning the first job comprises determining a difficulty of the first job; and
further comprising matching the difficulty of the first job to the classification.

6. The method of claim 5, wherein assigning the second job comprises determining a difficulty of the second job; and
further comprising matching the difficulty of the second job to a classification of the second developer.

7. The method of claim 6, further comprising updating the classification of the second developer based on an evaluation of the completed second building component.

8. A computer system configured to develop a building component for a device application: the computer system comprising:
a processor coupled to a memory, the processor configured to:
test a first developer on a proficiency to develop building components, each of the building components comprising one or more functions that operate independently of other building components;
determine a classification of the developer based on the testing;
assign a first job, based on the classification, to the first developer to develop a first building component; and
evaluate a first completed building component to update the classification, the first completed building component based on the job to develop the first building component.

9. The computer system of claim 8, wherein evaluate the first completed building component comprises the processor configured to verify that the first completed building component comprises functions that operate independently of other building components.

10. The computer system of claim 9, wherein the processor is further configured to:
assign a second job to a second developer to develop a second building component; and
evaluate a second completed building component that is based on the second building component.

11. The computer system of claim 10, wherein the processor is further configured to build a device application with the completed first building component and the completed second building component.

12. The computer system of claim 11, wherein assign the first job comprises the processor further configured to:
determine a difficulty of the first job; and
match the difficulty of the first job to the classification.

13. The computer system of claim 12, wherein assign the second job comprises the processor further configured to:
determine a difficulty of the second job; and
match the difficulty of the second job to a classification of the second developer.

14. The computer system of claim 13, wherein the processor is further configured to update the classification of the second developer based on an evaluation of the completed second building component.

15. A computer readable storage medium having data stored therein representing software executable by a computer, the software comprising instructions that, when executed, cause the computer readable storage medium to perform:
testing a first developer on a proficiency to develop building components, each of the building components comprising one or more functions that operate independently of other building components;
determining a classification of the developer based on the testing;
assigning a first job, based on the classification, to the first developer to develop a first building component; and
evaluating a first completed building component to update the classification, the first completed building component based on the job to develop the first building component.

16. The computer readable storage medium of claim 15, wherein the evaluating comprises verifying that the first completed building component comprises functions that operate independently of other building components.

17. The computer readable storage medium of claim 16, wherein the instructions further cause the computer readable storage medium to perform:
assigning a second job to a second developer to develop a second building component; and
evaluating a second completed building component that is based on the second building component.

18. The computer readable storage medium of claim 17, wherein the instructions further cause the computer readable storage medium to perform building a device application with the completed first building component and the completed second building component.

19. The computer readable storage medium of claim 18, wherein assigning the first job comprises determining a difficulty of the first job; and
wherein the instructions further cause the computer readable storage medium to perform matching the difficulty of the first job to the classification.

20. The computer readable storage medium of claim 19, wherein assigning the second job comprises determining a difficulty of the second job; and
wherein the instructions further cause the computer readable storage medium to perform matching the difficulty of the second job to a classification of the second developer.
